(19) United States
(12) Patent Application Publication
(10) Pub. No.: US 2010/0248602 A1
(43) Pub. Date: Sep. 30, 2010

(54) SHAFT PORTION FINISHING DEVICE

(75) Inventors: Shinichi Kakizawa, Tokyo (JP); Masaru Okuyama, Utsunomiya-shi (JP); Takashi Sasaki, Utsunomiya-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: HONDA MOTOR CO., LTD., Tokyo (JP)

(21) Appl. No.: 12/742,722

(22) PCT Filed: Nov. 12, 2008
(86) PCT No.: PCT/JP2008/070581

§ 371 Date: May 13, 2010

(30) Foreign Application Priority Data
Nov. 14, 2007 (JP) 2007-295276

(51) Int. Cl. B23F 21/00

(52) U.S. Cl. 451/540

(57) ABSTRACT

A shaft portion finishing device for finishing the surface of a work having a shaft portion comprises a first shoe and a second shoe clamping the shaft portion, and an abrasive cloth interposed between the first and second shoes and the shaft portion. On the end face of the first shoe facing the abrasive cloth, a portion set softer than the end face of the second shoe facing the abrasive disc exists.

### TECHNICAL FIELD

The present invention relates to a shaft portion finishing device for finishing the surface of a shaft portion by holding a coated abrasive in sliding contact with the shaft portion.

### BACKGROUND ART

One general crankshaft is schematically shown in its entirety in perspective in FIG. 4. The crankshaft 1 generally comprises weights 2, journals 3 positioned substantially at the centers of the weights 2, and pins 4 positioned at ends of the weights 2.

The pins 4 are operatively coupled to respective connecting rods (not shown) for displacing the pistons of an internal combustion engine. As well known in the art, since the crankshaft 1 rotates about its own central axis, the connecting rods are held in sliding contact with the pins 4 upon rotation of the crankshaft 1.

Therefore, the pins 4 are finished in order to reduce their surface roughness as much as possible. If the surface roughness of the pins 4 is excessive large, then it is not easy to retain a lubricating oil between the journals 3 and the connecting rods.

Patent Document 1 discloses a shaft portion finishing device for finishing the pins 4. The disclosed shaft portion finishing device has two pieces of rubber for gripping a journal 3 therebetween with a coated abrasive interposed between the pieces of rubber and the pin 4.

Patent Document 1: Japanese Laid-Open Patent Publication No. 61-178168

### DISCLOSURE OF THE INVENTION

Though the shaft portion finishing device disclosed in Patent Document 1 is capable of achieving a certain level of surface roughness, there is a disadvantage that it is not easy to meet demands for a smaller level of surface roughness.

It is a major object of the present invention to provide a shaft portion finishing device which is capable of finishing a shaft portion to a smaller level of surface roughness.

According to an embodiment of the present invention, a shaft portion finishing device for finishing the surface of a workpiece having a shaft portion comprises:

a first shoe and a second shoe for gripping the shaft portion; and

a coated abrasive for being interposed between the first shoe and the second shoe and the shaft portion;

wherein the first shoe has an end face facing the coated abrasive, the end face including a portion which is softer than an end face of the second shoe which faces the coated abrasive.

With the above arrangement, since the end face of the second shoe is hard and rigid, it is not deformed in conformity with the surface irregularities of the shaft portion before polishing. Therefore, it is easy to correct the shape of the surface of the shaft portion. Stated otherwise, it is easier to correct and hence planarize the surface roughness and undulations of the shaft portion than if only the softer first shoe is used.

The softer first shoe is elastic. Therefore, if the shaft portion includes a curved region, then the first shoe is deformed in conformity with the shape of the curved region. Consequently, the shaft portion can be polished to a nicety by the softer first shoe.

According to the present invention, as described above, the first shoe is softer and the second shoe is harder. As the end face of the harder second shoe is not deformed in conformity with the surface irregularities of the shaft portion before polishing, it is easy to correct the surface roughness and undulations of the shaft portion. Therefore, the surface roughness of the shaft portion can be improved. On the other hand, the shaft portion can be polished to a nicety by the softer and more elastic first shoe.

Preferably, a diamond abrasive grain is applied to the end face of the second shoe which faces the coated abrasive. The diamond abrasive grain bites into the coated abrasive, and hence prevents the coated abrasive from being positionally displaced.

The first shoe may be made of rubber, for example, and the second shoe may be made of steel, for example.

Preferably, the first shoe has a dimension along an axial direction of the shaft portion, the dimension being greater than that of the second shoe. In the case where the shaft portion includes a curved region, when the first shoe reaches the curved region, the first shoe rides onto the curved region because the end face of the first shoe is soft. Therefore, the curved region can be polished to a nicety.

### BRIEF DESCRIPTION OF THE DRAWINGS

FIG. 1 is a schematic side elevational view, partly in cross section, of a shaft portion finishing device in its entirety according to an embodiment of the present invention, the view being taken along a longitudinal direction of the shaft portion finishing device;

FIG. 2 is an enlarged fragmentary front elevational view of the shaft portion finishing device shown in FIG. 1;

FIG. 3 is an enlarged fragmentary front elevational view showing the manner in which a first presser of the shaft portion finishing device shown in FIG. 1 has reached a round edge of a crankshaft; and

FIG. 4 is a schematic perspective view of a general crankshaft in its entirety.

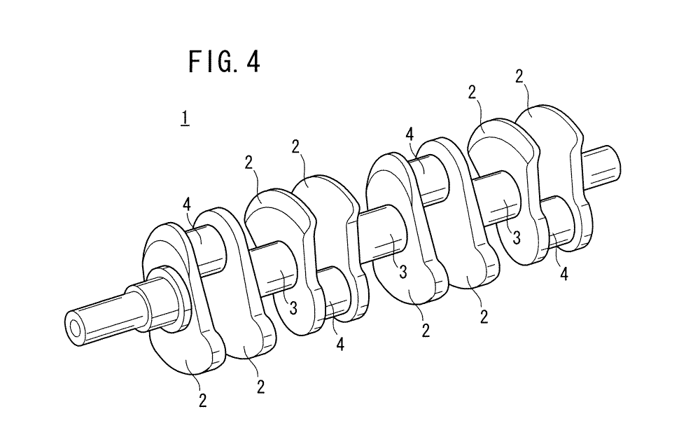

### BEST MODE FOR CARRYING OUT THE INVENTION

A shaft portion finishing device according to an embodiment of the present invention will be described in detail below with reference the accompanying drawings.

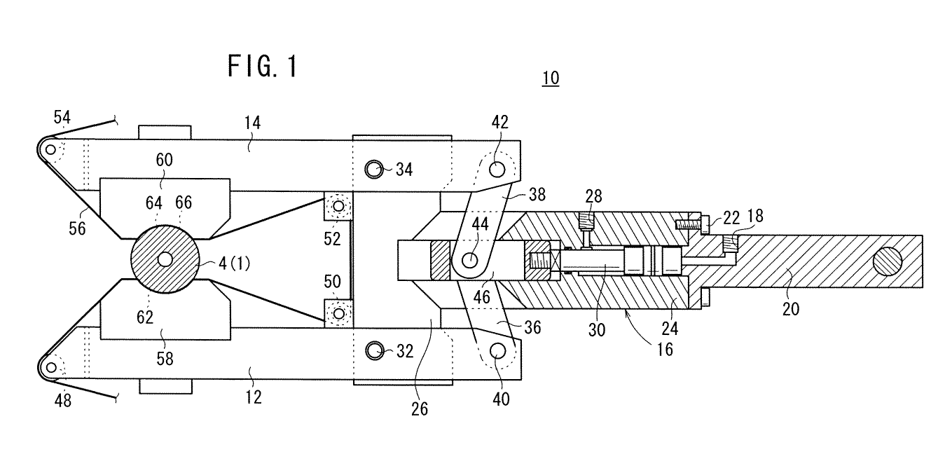

FIG. 1 is a schematic side elevational view, partly in cross section, of a shaft portion finishing device in its entirety according to an embodiment of the present invention, the view being taken along a longitudinal direction of the shaft portion finishing device. The shaft portion finishing device 10 includes a first clamp finger 12 and a second clamp finger 14 for gripping a pin 4 of a crankshaft 1 as a workpiece. In FIG. 1, the crankshaft 1 (the pin 4) extends in a direction perpendicular to the plane of paper.

The shaft portion finishing device 10 has an elongate base 16 including a first holder 20 with an inlet port 18 defined therein, a second holder 24 coupled to the first holder 20 by bolts 22, and a third holder 26, which is slightly wide, coupled to the second holder 24. The second holder 24 has an outlet port 28 defined therein.

The second holder 24 houses a pneumatic cylinder 30 therein. The inlet port 18 serves to supply working air to the pneumatic cylinder 30. The outlet port 28 serves to remove working air discharged from the pneumatic cylinder 30.

The first clamp finger 12 and the second clamp finger 14 are pivotally supported on the third holder 26 by a first support shaft 32 and a second support shaft 34, respectively. A first arm 36 and a second arm 38 have respective ends coupled to the third holder 26 by a third support shaft 40 and a fourth support shaft 42, respectively. The first arm 36 and the second arm 38 have respective other ends coupled to a rod 46 of the pneumatic cylinder 30 by a fifth support shaft 44.

A first roller 48, a second roller 50, a third roller 52, and a fourth roller 54 are mounted on the first clamp finger 12, the third holder 26, and the second clamp finger 14. A coated abrasive 56 is trained around the first roller 48, the second roller 50, the third roller 52, and the fourth roller 54 under a predetermined tension.

A first shoe 58 and a second shoe 60 for gripping the pin 4 are disposed respectively on the first clamp finger 12 and the second clamp finger 14 in confronting relation to each other. The coated abrasive 56 is supported by the first shoe 58 and the second shoe 60 and presses the pin 4 of the crankshaft 1.

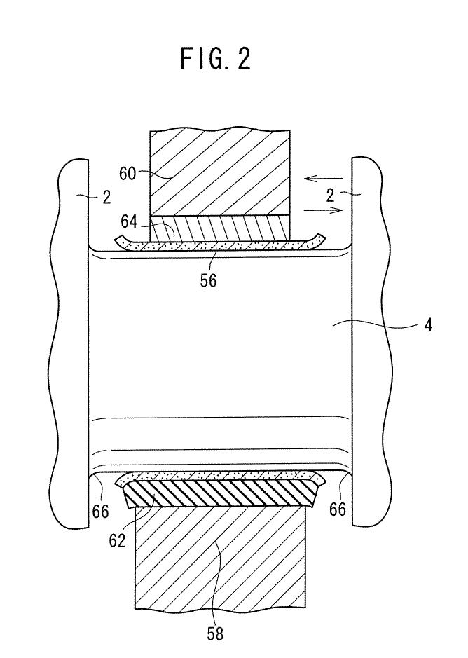

As shown in FIG. 2, the first shoe 58 and the second shoe 60 include a first presser 62 and a second presser 64, respectively. The dimension of the first presser 62 along the axis of the pin 4 of the crankshaft 1 (hereinafter referred to as “widthwise dimension”) is slightly greater than that of the first shoe 58. The first presser 62 is made of a relatively soft material, e.g., urethane rubber, and the second presser 64 is made of a relatively rigid material, e.g., steel with a diamond abrasive grain electrodeposited on its surface. According to the present embodiment, the thickness of the first presser 62 is substantially the same as the thickness of the second presser 64.

According to the present embodiment, as can be seen from FIG. 2, the widthwise dimension of the first shoe 58 is greater than the widthwise dimension of the second shoe 60.

Each of the pins 4 has curved round edges 66 on its ends.

The shaft portion finishing device 10 according to the present embodiment is basically constructed as described above. Operation and advantages of the shaft portion finishing device 10 will be described below.

For closing the first clamp finger 12 and the second clamp finger 14, working air is removed from the outlet port 28 to retract the rod 46 of the pneumatic cylinder 30. The first clamp finger 12 and the second clamp finger 14 that are pulled by the first arm 36 and the second arm 38 are turned about the first support shaft 32 and the second support shaft 34, respectively, until finally the first shoe 58 and the second shoe 60 grip the pin 4. At this time, the first presser 62 and the second presser 64 press the pin 4 through the coated abrasive 56.

The crankshaft 1 is now reciprocated a plurality of times along its longitudinal directions. The crankshaft 1 is reciprocated over a stroke within a range in which the first shoe 58 abuts against the weights 2.

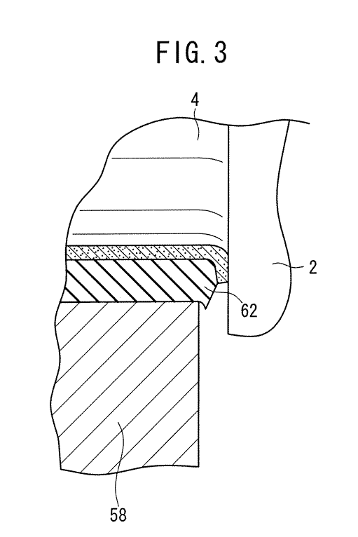

As described above, the first presser 62 is made of a relatively soft material, or in other words, an elastic material (e.g., urethane rubber). Therefore, when the first shoe 58 is displaced to a maximum stroke position, the first presser 62 and the coated abrasive 56 reach and ride onto the round edge 66, as shown in FIG. 3. Therefore, the round edge 66 is also polished.

On the other hand, the diamond abrasive grain on the surface of the second presser 64 bite into the coated abrasive 56. Therefore, the coated abrasive 56 is prevented from being positionally displaced due to slippage. The second presser 64 is thus effective to prevent the coated abrasive 56 from slipping.

Inasmuch as the second presser 64 is made of a rigid material (e.g., steel), the coated abrasive 56 held in intimate contact with the second presser 64 is not deformed in conformity with the surface irregularities of the pin 4. Therefore, the surface of the pin 4 is polished sequentially in the order from higher to lower surface irregularities.

According to the present embodiment, as can be understood from the foregoing, it is easy to correct and planarize the surface roughness and undulations of the surface of the pin 4, and it is possible to correct the shape of the surface of the pin 4 in a short period of time.

After the above polishing process is finished, working air is introduced from the inlet port 18 to advance the rod 46 of the pneumatic cylinder 30, thereby turning the first arm 36 and the second arm 38 about the fifth support shaft 44. In response to the turning movement of the first arm 36 and the second arm 38, the first clamp finger 12 and the second clamp finger 14 are turned respectively about the first support shaft 32 and the second support shaft 34, thereby moving the first shoe 58 and the second shoe 60 away from the pin 4. In other words, the first clamp finger 12 and the second clamp finger 14 are opened.

The pin 4 is then turned to a certain degree, and the coated abrasive 56 is fed a predetermined distance along the first roller 48 through the fourth roller 54. Thereafter, working air is removed from the outlet port 28 to close the first clamp finger 12 and the second clamp finger 14 again, thereby causing the first presser 62 and the second presser 64 to press the pin 4. The above process is then carried out on another region of the pin 4.

As described above, since the second presser 64 is made of a rigid material, the shape of the surface of the pin 4 can be corrected, and at the same time the surface roughness thereof can be improved. Furthermore, since the first presser 62 is made of an elastic material, the round edges 66 at the boundaries between the pin 4 and the weights 2 can be polished to a nicety.

Specifically, when a workpiece is finished as described above, the surface roughness thereof is improved much better than with the background art. According to the present invention, therefore, though the shaft portion finishing device 10 is substantially similar in structure to the shaft portion finishing device disclosed in Patent Document 1, the shaft portion finishing device 10 is capable of reducing the surface roughness of the workpiece.

In the above embodiment, urethane rubber is used as the material of the first presser 62, and steel as the material of the second presser 64, as an example. However, both the pressers are not limited to these materials. The first presser 62 may be made of any other elastic materials such as rubber, and the second presser 64 may be made of any other rigid materials such as metal materials. The thicknesses of the first presser 62 and the second presser 64 may be different from each other, e.g., the thickness of the first presser 62 may be greater than the thickness of the second presser 64.

The workpiece to be machined by the shaft portion finishing device 10 is not limited to the pins 4 of the crankshaft 1, but may be a shaft member or a shaft portion of a given member.

The journals 3 may also be polished in the same manner as the pins 4.

1. A shaft portion finishing device for finishing the surface of a workpiece having a shaft portion, comprising:
a first shoe and a second shoe for gripping the shaft portion; and
a coated abrasive for being interposed between the first shoe and the second shoe and the shaft portion;
wherein the first shoe has an end face facing the coated abrasive, the end face including a portion which is softer than an end face of the second shoe which faces the coated abrasive.

2. A shaft portion finishing device according to claim 1, wherein a diamond abrasive grain is applied to the end face of the second shoe which faces the coated abrasive.

3. A shaft portion finishing device according to claim 1, wherein the first shoe is made of rubber and includes a presser as the softer portion, and the second shoe includes a presser made of steel.

4. A shaft portion finishing device according to claim 3, wherein the presser of the first shoe is made of urethane rubber.

5. A shaft portion finishing device according to claim 1, wherein the first shoe has a dimension along an axial direction of the shaft portion, the dimension being greater than that of the second shoe.
